(19) United States
(12) Patent Application Publication
(10) Pub. No.: US 2026/0160368 A1
(43) Pub. Date: Jun. 11, 2026

(54) DEVICE FOR LOCKING A BAYONET CLOSURE

(71) Applicant: NORMA GERMANY GMBH, Maintal (DE)

(72) Inventors: Michal STACH, Pilica (PL); Przemyslaw KULIG, Pilica (PL)

(21) Appl. No.: 18/704,543

(22) PCT Filed: Oct. 6, 2022
(86) PCT No.: PCT/EP2022/077845

§ 371 Date: Apr. 25, 2024

(30) Foreign Application Priority Data
Oct. 25, 2021 (DE) 10 2021 127 685.3

(51) Int. Cl. F16L 37/252; F16L 37/088; F16L 37/14

(52) U.S. Cl. CPC F16L 37/252; F16L 37/0885; F16L 37/144

(57) ABSTRACT

A device for locking a bayonet closure has a first connection partner with at least one coupling projection and a second connection partner with at least one coupling channel. The at least one coupling projection and the coupling channel form a bayonet closure. The at least one coupling projection can be inserted into the at least one coupling channel via a movement along a longitudinal axis of the second connection partner and rotation in a first circumferential direction about the longitudinal axis. The first connection partner has at least one first securing partner and the second connection partner has at least one second securing partner. The at least one first securing partner and the second securing partner are designed to lock a rotation in a second circumferential direction.

### INTRODUCTION

The disclosures relates to a device for arresting a bantonet closure.

Fluid lines are used in order to conduct fluids between different positions within apparatuses or items such as vehicles. It is possible here, during the assembly of the apparatuses or items, for a plurality of fluid lines to be joined together to form a common fluid line. For the purpose of connecting the fluid lines, the end pieces of the fluid lines are connected to coupling pieces. The coupling pieces can be fastened on connecting pieces, by which the fluid lines can be connected to one another for fluid communication.

It is known from DE 10 2020 105 395 A1 to fasten the coupling pieces on the connecting piece by means of a bayonet closure. Quick coupling of the fluid lines can be achieved in this way.

For the purpose of securing the connection between the coupling piece and the connecting piece, the coupling piece and the connecting piece can be welded to one another. To this end, a welding ring can be arranged within the connecting piece.

### SUMMARY

It is an object of an embodiment of the disclosure to provide an improved device which allows simplified assembly and is cost-effective.

In the case of a device for arresting a bayonet closure, wherein the device has a first connecting partner with at least one coupling protrusion for locking the connection and a second connecting partner with at least one coupling channel, wherein the at least one coupling protrusion and the coupling channel form a bayonet closure, wherein the at least one coupling protrusion can be introduced into the at least one coupling channel by means of a movement along a longitudinal axis of the second connecting partner and a subsequent rotation in a first circumferential direction about the longitudinal axis, provision is made according to an embodiment for the first connecting partner to have at least one first securing partner and for the second connecting partner to have at least one second securing partner, wherein the at least one first securing partner and the at least one second securing partner are designed to arrest a rotation in a second circumferential direction, counter to the first circumferential direction, when the at least one coupling protrusion has been introduced into the at least one coupling channel by means of the movement along the longitudinal axis and the rotation in the first circumferential direction.

The disclosure, per an embodiment, provides a quick coupling between the first connecting partner and the second connecting partner that is secured by the at least one first securing partner and the at least one second securing partner in a connected state. The connection between the first connecting partner and the second connecting partner cannot be released without the at least one first securing partner and the at least one second securing partner being released from one another. The first connecting partner and the second connecting partner are connected to one another here by way of a bayonet closure. The at least one coupling protrusion of the first connecting partner and the at least one coupling channel of the second connecting partner are coupled with one another by an insert-and-rotate movement. To this end, the at least one coupling channel can have a first channel portion, which extends along a longitudinal axis of the second connecting partner, and a second channel portion, which extends at least part of the way about the longitudinal axis. The first channel portion and the second channel portion are connected to one another at a corner. In an analogous manner, the at least one coupling protrusion can have a first protrusion portion and a second protrusion portion. The first protrusion portion can extend parallel to the longitudinal axis and the second protrusion portion can extend about the longitudinal axis, wherein the first and second protrusion portions are connected to one another at a corner. The at least one coupling protrusion is then inserted into the first channel portion along the longitudinal axis of the second connecting partner. At the corner, the at least one coupling protrusion can be introduced into the second channel portion by a rotation about the longitudinal axis of the second connecting partner, in a first circumferential direction about the longitudinal axis. As soon as the at least one coupling protrusion reaches its end position in the at least one coupling channel, the first securing partner on the first connecting partner and the second securing partner on the second connecting partner interact with one another. They arrest a rotation of the at least one coupling protrusion in a second circumferential direction, which is counter to the first circumferential direction. The at least one coupling protrusion therefore cannot be moved out of the at least one coupling channel without release of the arresting action provided by the first and second securing partners. The device can have a multiplicity of coupling protrusions. Furthermore, the device then has a number of coupling channels which corresponds to the number of coupling protrusions. For example, the device can have four coupling protrusions and four coupling channels. The coupling between the first and second connecting partners can thereby be arrested in a straightforward manner. There is no need for the coupling to be welded. Therefore, in addition, there is no need for cost-intensive welding equipment. Furthermore, it is possible for the tolerances of the first and second connecting partners to be reduced, so that a lower level of force is required to establish the coupling. The disclosure, per an embodiment, thereby provides an improved device which allows simplified assembly and is cost-effective.

According to one example, the at least one first securing partner and the at least one second securing partner can form an undercut in the direction of the second circumferential direction when the at least one coupling protrusion has been introduced into the at least one coupling channel by way of the movement along the longitudinal axis and the rotation in the first circumferential direction.

As soon as the at least one coupling protrusion has been coupled with the at least one coupling channel, the first securing partner and the second securing partner can butt against one another via the undercut. In the second circumferential direction, the first and second securing partners have then been connected to one another via a form fit.

According to a further example, the at least one first securing partner and the at least one second securing partner can form a latching connection when the at least one coupling protrusion has been introduced into the at least one coupling channel by way of the movement along the longitudinal axis and the rotation in the first circumferential direction.

The latching connection causes an acoustic signal to be emitted when the securing partners latch in, and this signal can indicate to a user that arresting action has taken place. This further increases safety during the assembly of the device. The at least one first securing partner can have, for example, a latching nose.

In a further example, the at least one first securing partner can have a latching lever and the at least one second securing partner can have a latching nose.

In this example, the at least one first securing partner can be subjected to stressing when the at least one coupling protrusion is being coupled with the at least one coupling channel. It is possible here for the latching lever to cross over the latching nose when the at least one coupling protrusion is being introduced into the at least one coupling channel. Once the at least one coupling protrusion and the at least one coupling channel have been coupled, the latching lever can be relieved of stressing and can latch in on the latching nose. To this end, a recess can be provided on the at least one coupling channel behind the latching nose, as seen along the first circumferential direction, the latching lever being moved into this recess by the prestressing action once the latching lever has passed over the latching nose.

Furthermore, the at least one first securing partner can be arranged on the first connecting partner for example separately from the at least one coupling protrusion.

It is thereby possible to separate the arresting function from the coupling function on the first connecting partner. The first channel portion of the at least one coupling channel can then be designed so as to be circumferentially for example wider than the width of the at least one coupling protrusion in the circumferential direction. The width of the first channel portion can for example be of such an extent that a first securing partner, which is assigned to the at least one coupling protrusion and is arranged separately from the coupling protrusion, can likewise be introduced into the first channel portion. As an alternative, the first channel portion can have an intermediate wall, which extends parallel to the longitudinal axis. It is possible here for the coupling protrusion to be introduced on the one side of the intermediate wall and for the first securing partner to be introduced on the other side of the intermediate wall.

According to one example, the at least one first securing partner can be arranged on the at least one coupling protrusion.

The at least one first securing partner and the at least one coupling protrusion are thereby connected directly to one another. They can be produced then in one piece. Furthermore, the stability of the first securing partner can thereby be increased.

According to a further example, the first securing partner can be arranged on a rear end portion of the coupling protrusion, as seen in the first circumferential direction.

If the attempt is made to release the arrested coupling between the first connecting partner and the second connecting partner, the first securing partner is subjected to a compressive force which pushes the first securing partner against the coupling protrusion. The first securing partner has increased stability as a result.

According to one example, the at least one second securing partner can be arranged on the at least one coupling channel.

This means that arresting action between the first and second securing partners can be implemented in a straightforward and reliable manner. There is therefore no need for a dedicated channel for the first securing partner, per an embodiment. Furthermore, the first and second securing partners are protected by the coupling channel when they arrest the coupling action. Accidental release of the arresting action is thereby avoided.

According to another example, the at least one second securing partner can be arranged on the second connecting partner separately from the at least one coupling channel.

In this case, it is then possible for the first securing partner to have a dedicated channel, on which the second securing partner is then arranged. As an alternative, the first securing partner and the second securing partner can interact with one another on an outer surface of the device when the at least one coupling protrusion has been introduced into the at least one coupling channel by means of the movement along the longitudinal axis and the rotation in the first circumferential direction.

In a further example, the first connecting partner can have a coupling piece for a fluid line and the second connecting partner can have a connecting piece for fluid lines.

The fluid lines can be used in a vehicle in order to connect for example different components of a cooling-fluid circuit to one another for fluid communication.

### BRIEF DESCRIPTION OF THE FIGURES

Further features, details and advantages of the disclosure can be gathered from the wording of the claims and from the following description of exemplary embodiments with reference to the drawings, in which:

FIG. 1 shows a schematic illustration of the device in an exploded view;

FIG. 2a and b show a schematic illustration of the device;

FIG. 3 shows a schematic sectional illustration of the device;

FIGS. 4a-d show a schematic illustration of the sequence required for connecting the connecting partners;

FIG. 5 shows a schematic illustration of an alternative example of the first connecting partner; and

FIG. 6 a and b show a schematic illustration of a further alternative example of the first connecting partner.

### DETAILED DESCRIPTION

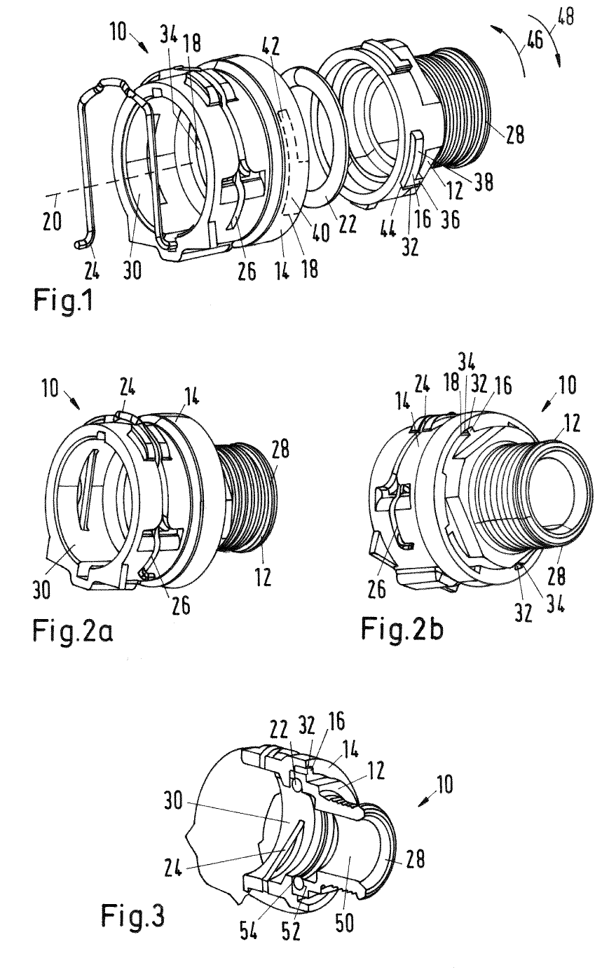

The device for arresting a bayonet closure is referenced in its entirety by reference sign 10 in FIG. 1. The example in FIG. 1 here shows an exploded illustration of the components of the device 10.

The device 10 has a first connecting partner 12 and a second connecting partner 14. Furthermore, the device can have a sealing element 22 between the first and second connecting partners 12, 14.

The first connecting partner 12 can be designed in the form of a coupling piece 28 for a fluid line. A first end portion of the coupling piece 28 can then be inserted into an opening of the fluid line, in order for the fluid line to be connected to the coupling piece 28.

The first connecting partner 12 has at least one coupling protrusion 16, which can be arranged on that end portion of the coupling piece 28 which is located opposite the first end portion. In the example according to FIG. 1, the first connecting partner 12 has four coupling protrusions 16, which are distributed at equal distances from one another over the circumference of the first connecting partner 12.

In this example, the coupling protrusion has an L shape, with a first protrusion portion 36, which extends along the longitudinal axis 20, and a second protrusion portion 38, which extends about the longitudinal axis 20. The first protrusion portion 36 and the second protrusion portion 38 can be connected to one another at a corner.

The second connecting partner 14 can have a connecting piece 30, which can be coupled with another connecting piece, which is connected to a further fluid line. A clip 24 can be provided for the purpose of securing the coupling between the connecting piece 30 and the other connecting piece.

The second connecting partner 14, furthermore, has a coupling channel 18, which can be arranged in an inner wall of an opening of the second connecting partner 14. The coupling channel 18 can have a first channel portion 40 and a second channel portion 42. The first channel portion 40 can extend parallel to the longitudinal axis 20 and the second channel portion 42 can extend about the longitudinal axis. The two channel portions 40, 42 can be connected to one another at a corner.

The width of the first channel portion 40 in the circumferential direction about the longitudinal axis 20 corresponds to the extent of the coupling protrusion 16 in the circumferential direction about the longitudinal axis 20.

The extent of the second channel portion 42 in the circumferential direction about the longitudinal axis 20 corresponds to the extent of the second protrusion portion 38 in the circumferential direction about the longitudinal axis 20. The second channel portion 42 can therefore receive the second protrusion portion 38.

The at least one coupling protrusion 16 can therefore be introduced into the coupling channel 18 by means of an insertion movement along the longitudinal axis and a subsequent rotary movement in a first circumferential direction 46 about the longitudinal axis. The first connecting partner 14 and the second connecting partner 16 are therefore coupled by means of an insert-and-rotate movement. The coupling protrusion 16 and the coupling channel 18 thereby form a bayonet closure.

It is thus possible for a fluid line which is connected to the first connecting partner 12 and/or the coupling piece 28 to be connected to the connecting piece 30 for fluid communication.

Furthermore, the first connecting partner 12 has at least one first securing partner 32, which in this example is fastened on the at least one coupling protrusion 16.

The second connecting partner 14 has at least one second securing partner 34, which in this example is arranged on the coupling channel 18.

The first securing partner 32 and the second securing partner 34 interact when the at least one coupling protrusion 16 has been introduced into the at least one coupling channel 18 by means of the movement along the longitudinal axis 20 and the rotation in the first circumferential direction 46. The two securing partners 32, 34 then arrest the coupling between the first connecting partner 12 and the second connecting partner 14. The arresting action can be achieved in that rotation counter to the first circumferential direction 46, i.e. in a second circumferential direction 48, is blocked or prevented.

The first connecting partner 12 can have as many first securing partners 32 as coupling protrusions 16. A respective first securing partner 32 is, in that case, connected to a respective coupling protrusion 16.

FIGS. 2a and 2b illustrate the connecting partners 12, 14 coupled with one another.

FIG. 2a illustrates a view into an opening of the connecting piece 30. Another connecting piece, which is connected to a different fluid line, can be introduced into this opening. In the view from FIG. 2a, the clip 24 has been introduced into a slot 26 of the connecting piece 14.

FIG. 2b shows a view of an opening which is part of the coupling piece 28 and is located opposite the opening of the connecting piece 30 when the two connecting partners 12, 14 have been coupled with one another.

Furthermore, the two securing partners 32, 34 are visible. In this example, the at least one first securing partner 32 and the second securing partner 34 are designed in the form of latching noses. The first securing partner 32 is arranged on the first protrusion portion 36 on an end portion 44 of the coupling protrusion 16, wherein the end portion 44 is arranged at the rear of the first protrusion portion 36, as seen in the first circumferential direction 46 about the longitudinal axis 20.

In this example, the two securing partners 32, 34 form an undercut in the second circumferential direction 48. The two securing partners 32, 34 here each have a radially running edge. The two edges of the securing partners 32, 34 butt against one another when the at least one coupling protrusion 16 has been introduced into the at least one coupling channel 18 via the movement along the longitudinal axis 20 and the rotation in the first circumferential direction 46. They thereby establish a form fit in the second circumferential direction 48.

The first protrusion portion 36 and thus also the rear end portion 44 are positioned in an entry region of the first channel portion 42. In particular the first securing partner 32 is thereby arranged so as to be accessible from the outside, in which case the undercut between the first securing partner 32 and the second securing partner 34 can be breached by means of a tool in order for the arresting action to be released.

FIG. 3 shows a sectional illustration of the device, wherein a sealing element 22 can be arranged between the two connecting partners 12, 14 when the connecting partners 12, 14 are being coupled. The sealing element 22 is mounted on a holder 52, which forms part of the first connecting partner 14 and is arranged on an inner wall 50 of the coupling piece 28. The sealing element 22 projects, along the longitudinal direction 20, partially beyond the holder 52. When the first and second connecting partners 12, 14 are coupled, that part of the sealing element 22 which projects, in the longitudinal direction 20, out of the holder 52 butts against an abutment surface 54 of the second connecting partner 14. An outwardly directed gap which may possibly remain between the two connecting partners 12, 14 when the two connecting partners 12, 14 are coupled is sealed in a fluid-tight manner in the process.

Those portions of the first and second connecting partners 12, 14 which are adjacent to the possible gap between the two connecting partners 12, 14 are thereby not in contact with the fluid flowing through the connecting partners 12, 14. These portions can therefore have different material properties to portions of the connecting partners 12, 14 which are in contact with the fluid.

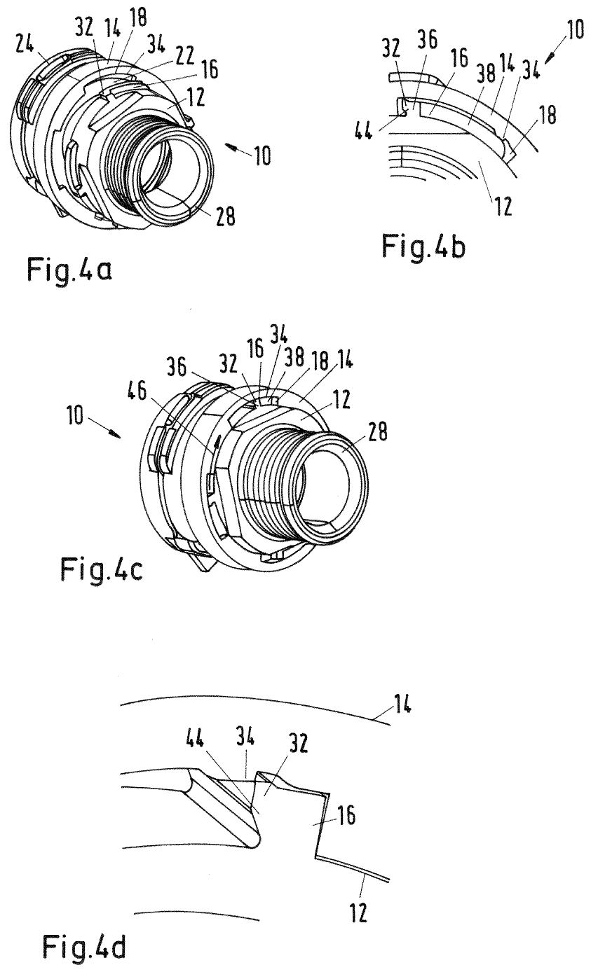

The coupling operation between the first connecting partner 12 and the second connecting partner 14 is explained in more detail in FIGS. 4a to 4d.

In FIG. 4a, the two connecting partners 12, 14 have been separated from one another. The first connecting partner 12 and the second connecting partner 14 have been oriented in relation to one another such that the coupling protrusions 16 and the first channel portions 40 are aligned with one another parallel to the longitudinal axis 20.

FIG. 4b shows, in this respect, a detail-specific view, parallel to the longitudinal axis 20, into the first channel portion 40. In this arrangement, the coupling protrusion 16 can be introduced into the first channel portion 40 of the coupling channel 18 via a movement of the first connecting partner 12 parallel to the longitudinal axis. In this case, the securing partners 32, 34 are arranged at a distance from one another and do not interact.

Once the coupling protrusion 16 has been introduced into the first channel portion 40, the second protrusion portion 38 can be introduced into the second channel portion 42 by a rotation of the first connecting partner 12 in the first circumferential direction 46, as is illustrated in FIG. 4c. During the introduction operation, the securing partners 32, 34 do not interact since they are relatively far apart from one another. When the first connecting partner 12 is rotated, the two securing partners 32, 34 are moved toward one another.

The rotation in the first circumferential direction 46 can take place until the second protrusion portion 38 has been introduced all the way into the second channel portion 42. Before the second protrusion portion 38 has been introduced all the way into the second channel portion 42, the first securing partner 32, which in this example is designed in the form of a latching nose, passes over the second securing partner 34.

When the second protrusion portion 38 has been introduced all the way into the second channel portion 42, the first securing partner 32 latches in on the second securing partner 34, as is illustrated in FIG. 4d. As seen in a view along the first circumferential direction 46, an edge of the first securing partner 32 that is oriented radially in relation to the longitudinal axis 20 undercuts an edge of the second securing partner 34 that is oriented radially in relation to the longitudinal axis 20. The edges can also be in a different orientation.

The bayonet closure, which is formed by the at least one coupling protrusion 16 and the at least one coupling channel 18, is then arrested by the two securing partners 32, 34.

In this example, the first securing partner 32 is arranged on the rear end portion 44 of the first protrusion portion 36 and projects into the entry region of the first channel portion 42.

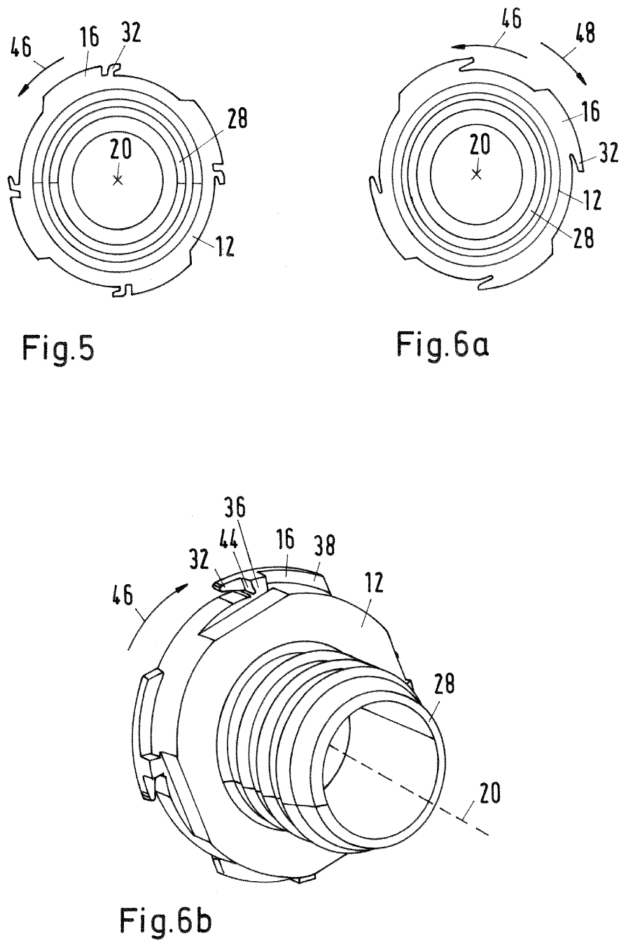

FIG. 5 illustrates a further exemplary embodiment of the device 10. In this example, the first securing partners 32 are arranged separately from the coupling protrusions 16. Furthermore, the first securing partners 32 are designed in the form of latching levers.

FIGS. 6a and 6b illustrate a third exemplary embodiment of the device 10.

The first securing partners 32 here are designed in the form of latching levers, which are connected to the coupling protrusions 16, as is illustrated in FIG. 6a. The first securing partners 32 project along the second circumferential direction 48 from the rear end portion 44 of the first protrusion portion 36.

According to FIG. 6b, the first securing partners 32, which are designed in the form of latching levers, project, in the form of an extension of the second protrusion portions 38, in the second circumferential direction 48. Furthermore, the first securing partners 32 can extend parallel to the longitudinal axis 20 merely along part of the first protrusion portion 36. Once the coupling protrusions 16 have been introduced into the first channel portions 40, the first securing partners 32 are in a state in which they have been arranged within the coupling channel 18 at a distance from the entry region of the first channel portion 40.

When the bayonet closure has been arrested, the first securing partners 32, in comparison with the exemplary embodiments in which they extend into the entry region, can be reached from the outside only by additional effort being expended by a tool. The arresting action can therefore be released only by additional effort being expended, so that the safety of the connection between the first connecting partner 12 and the second connecting partner 14 increases.

The invention is not restricted to one of the embodiments described above, but can be modified in various ways.

All of the features and advantages which can be gathered from the claims, the description and the drawing, including structural details, spatial arrangements and method steps, may be essential to the invention both individually and in a wide variety of different combinations.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE NUMERALS

10 device for arresting a bayonet closure
12 first connecting partner
14 second connecting partner
16 coupling protrusion
18 coupling channel
20 longitudinal axis
22 sealing element
24 clip
26 slot
28 coupling piece
30 connecting piece
32 first securing partner
34 second securing partner
36 first protrusion portion
38 second protrusion portion
40 first channel portion
42 second channel portion
44 end portion
46 first circumferential direction
48 second circumferential direction
50 inner wall
52 holder
54 abutment surface

1. A device for arresting a bayonet closure, wherein the device comprises a first connecting partner with at least one coupling protrusion for locking the connection and a second connecting partner with at least one coupling channel, wherein the at least one coupling protrusion and the coupling channel form a bayonet closure, wherein the at least one coupling protrusion can be introduced into the at least one coupling channel via a movement along a longitudinal axis of the second connecting partner and a subsequent rotation in a first circumferential direction about the longitudinal axis, wherein the first connecting partner has at least one first securing partner and the second connecting partner has at least one second securing partner wherein the at least one first securing partner and the at least one second securing partner are designed to arrest a rotation in a second circumferential direction, counter to the first circumferential direction, when the at least one coupling protrusion has been introduced into the at least one coupling channel via the movement along the longitudinal axis and the rotation in the first circumferential direction.

2. The device as claimed in claim 1, wherein the at least one first securing partner and the at least one second securing partner form an undercut in the direction of the second circumferential direction when the at least one coupling protrusion has been introduced into the at least one coupling channel via the movement along the longitudinal axis and the rotation in the first circumferential direction.

3. The device as claimed in claim 1, wherein the at least one first securing partner and the at least one second securing partner form a latching connection when the at least one coupling protrusion has been introduced into the at least one coupling channel via the movement along the longitudinal axis and the rotation in the first circumferential direction.

4. The device as claimed in claim 3, wherein the at least one first securing partner has a latching lever and the at least one second securing partner has a latching nose.

5. The device as claimed in claim 1, wherein the at least one first securing partner is arranged on the first connecting partner separately from the at least one coupling protrusion.

6. The device as claimed in claim 1, wherein the at least one first securing partner is arranged on the at least one coupling protrusion.

7. The device as claimed in claim 6, wherein the first securing partner is arranged on a rear end portion of the coupling protrusion, as seen in the first circumferential direction.

8. The device as claimed in claim 1, wherein the at least one second securing partner is arranged on the at least one coupling channel.

9. The device as claimed in claim 1, wherein the at least one second securing partner is arranged on the second connecting partner separately from the at least one coupling channel.

10. The device as claimed in claim 1, wherein the first connecting partner has a coupling piece for a fluid line and the second connecting partner has a connecting piece for fluid lines.
